(19) United States
(12) Patent Application Publication
(10) Pub. No.: US 2026/0044236 A1
(43) Pub. Date: Feb. 12, 2026

(54) Context-Adaptive Touch Suppression Adjustment

(71) Applicant: Google LLC, Mountain View, CA (US)

(72) Inventors: Mark Chang, Queensland (AU); Chiayun Kuan, San Jose, CA (US)

(73) Assignee: Google LLC, Mountain View, CA (US)

(21) Appl. No.: 19/296,300

(22) Filed: Aug. 11, 2025

Related U.S. Application Data
(60) Provisional application No. 63/682,109, filed on Aug. 12, 2024.

(51) Int. Cl. G06F 3/041; G06F 3/044

(52) U.S. Cl. CPC G06F 3/04186; G06F 3/044

(57) ABSTRACT

A method for dynamically adjusting touch suppression on a capacitive touch screen of an electronic device is described. The method includes receiving touch screen data associated with a touch event and extracting a feature of the touch event. Contextual information related to the device's state is received, and based on both the feature and the contextual information, a touch sensitivity indicating a likelihood of the touch event being a user input is determined. A touch suppression of the capacitive touch screen is then adjusted based on the determined touch sensitivity, changing touch performance by distinguishing intended user inputs from unintended touch contacts.

### CROSS-REFERENCE TO RELATED APPLICATION

This application claims the benefit of U.S. Provisional Patent Application Ser. No. 63/682,109 filed on Aug. 12, 2024, the disclosure of which is incorporated by reference herein in its entirety.

### BACKGROUND

The field of touch-sensitive input systems for electronic devices is well-established, encompassing various technologies that enable user interaction through physical contact (or touch) with a display surface. For example, electronic devices frequently include a capacitive touch screen display that a user can interact with through a touch contact (e.g., touching with a finger) to provide a touch input to the device. A touch input corresponds to the interpreted meaning and action of the touch contact (e.g., that the user selected a button in a user interface), which may lead to a specific response or action by the device (e.g., an application opens). The device captures touch signals that correspond to the touch contacts and generates touch events, also referred to as “touch reports.”

Touch events may represent both intended and unintended touch contacts with the capacitive touch screen display. To improve user experience, systems may utilize touch suppression algorithms (e.g., grip suppression algorithms, palm rejection algorithms) to differentiate intended touch contacts from unintended touch contacts and to suppress unintended touch contacts. In this way, a touch event is less likely to represent an unintended touch contact. Touch suppression algorithms frequently rely on machine learning models to classify touch contacts.

A main challenge in differentiating between intended and unintended touch contacts is the similarity of the signal characteristics between them. This similarity can result in a false suppression of intended touch contacts, which can cause users to perceive suboptimal touch responsiveness, especially when the device is trying to suppress unintended touches based on limited sensor information. This similarity also makes it difficult for a single, static set of configurations to distinguish between various types of touch contacts across diverse operating conditions, environments, and usage scenarios.

Furthermore, current touch-sensitive input systems often exhibit variations in touch signal strength based on the device's grounding conditions. For instance, a device placed on a non-conductive surface or without a stable ground connection may yield lower touch signal strengths than when held by a user or connected via a cable. These fluctuations in signal strength can lead to inconsistencies in the performance of touch suppression algorithms, particularly when the touch suppression algorithms utilize features derived from signal strength as an input.

Consequently, conventional touch-sensitive input systems frequently exhibit suboptimal responsiveness or inadvertently suppress intended user touch contacts, especially when operating under challenging conditions (e.g., low grounding) or in particular device orientations. These limitations lead to challenges when the system fails to robustly and accurately interpret touch events across the full spectrum of real-world usage scenarios.

### SUMMARY

The disclosed subject matter relates to dynamically adjusting touch suppression on an electronic device to change touch sensitivity based on various contextual conditions. A method of operation can include receiving touch screen data associated with a touch event on a capacitive touch screen of an electronic device and extracting at least one feature of the touch event from the touch screen data. The method can also include receiving contextual information associated with a state of the electronic device and determining, based on the feature and the contextual information, a touch sensitivity indicative of a likelihood of a touch event being a user input. Additionally, the method can include adjusting, based on the determined touch sensitivity, a touch suppression of the capacitive touch screen for identifying intentional touch contacts for the electronic device.

An apparatus can implement aspects of the disclosed subject matter. Such an apparatus can include a capacitive touch screen configured to generate touch screen data, and a processor. The processor can be configured to receive touch screen data associated with a touch event on the capacitive touch screen and extract at least one feature of the touch event from the touch screen data. The processor can also be configured to receive contextual information associated with a state of the electronic device and determine, based on the feature and the contextual information, a touch sensitivity indicative of a likelihood of a touch event being a user input. Furthermore, the processor can be configured to adjust, based on the determined touch sensitivity, a touch suppression of the capacitive touch screen for identifying intentional touch contacts for the electronic device.

A computer-readable storage medium having stored thereon instructions can, responsive to execution by a processor, cause an electronic device to perform operations consistent with the disclosed subject matter. The operations can include receiving touch screen data associated with a touch event on a capacitive touch screen of the electronic device and extracting at least one feature of the touch event from the touch screen data. The operations can also include receiving contextual information associated with a state of the electronic device and determining, based on the feature and the contextual information, a touch sensitivity indicative of a likelihood of a touch event being a user input. Additionally, the operations can include adjusting, based on the determined touch sensitivity, a touch suppression of the capacitive touch screen for identifying intentional touch contacts for the electronic device.

Through context-adaptive touch suppression adjustment, the accuracy of distinguishing between intended and unintended touch contacts on an electronic device's capacitive touch screen can be enhanced. This is achieved by dynamically adapting the touch suppression levels based on real-time contextual information and characteristics of the touch event. This approach offers the advantage of mitigating the challenges posed by variations in touch signal characteristics that occur due to diverse operating conditions, environments, and usage scenarios, which can otherwise lead to false suppression of intended user inputs or a suboptimal user experience. The described adjustments to touch sensitivity can prevent unintentional interactions (e.g., grip touches, palm touches, touches in a pocket or bag) while preserving responsive and accurate detection of deliberate user inputs across a wide range of operational contexts.

This Summary is provided to introduce simplified concepts for context-adaptive touch suppression adjustment, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

In the Drawings, the use of same numbers in different instances may indicate similar features or components. In the Detailed Description below, the first digit of a reference character (e.g., call out number) may correlate with the first figure number in which the reference character is labeled. For example, reference characters that start with a 2 (e.g., suppression module 216, contextual information 218) may represent details first called out with respect to FIG. 2. The details of one or more implementations of context-adaptive touch suppression adjustment are described in this document with reference to the following Drawings.

FIG. 1 is an illustration of an example data processing environment in which aspects of context-adaptive touch suppression adjustment may be implemented.

FIG. 2 illustrates an example electronic device that can implement aspects of context-adaptive touch suppression adjustment.

FIG. 3 illustrates an example suppression module utilized by an electronic device to perform aspects of context-adaptive touch suppression adjustment.

FIG. 4 is a diagram that illustrates an example implementation of context-adaptive touch suppression adjustment, which includes dynamic feature normalization where features are normalized for machine learning classifiers.

FIG. 5 depicts an example method performed by a computing system in accordance with one or more aspects for context-adaptive touch suppression adjustment.

FIG. 6 depicts an example method performed by a computing system in accordance with one or more aspects for context-adaptive touch suppression adjustment.

FIG. 7 illustrates various components of an example computing system that can be implemented as any type of client, server, and/or electronic device as described with reference to the previous figures to implement aspects of context-adaptive touch suppression adjustment.

### DETAILED DESCRIPTION

### Overview

Electronic devices frequently include a capacitive touch screen display. A capacitive display or capacitive touch screen operates by creating an electrostatic field across its surface. When a user interacts with (e.g., provides a touch input to) the capacitive display by touching it with a conductive object (e.g., a finger, a palm, a stylus, other means of making a touch contact), the conductive object draws a small amount of electrical charge. This action causes a localized change in the electrostatic field, specifically a change in capacitance. Through capacitive touch sensing, a touch-sensitive input system of the capacitive display measures the capacitance. Through touch recognition (e.g., by touch recognition algorithms), the measured capacitances are used to determine changes in capacitances and produce a list of touch events (also referred to as “touch reports”) that reflect the positions and statuses of the touch contact. Through touch suppression (e.g., by touch suppression algorithms), touch events that are not user intended and/or are invalid (e.g., a palm with large contacts) are identified and suppressed.

Disclosed are techniques and apparatuses, implemented on electronic devices, for dynamically adjusting touch suppression to change touch sensitivity (e.g., to accurately suppress unintentional touches) based on various contextual conditions. The adjustment of touch suppression can directly influence the touch sensitivity of the capacitive display. Touch sensitivity refers to how easily and accurately the capacitive display can detect a user's touch contacts. A high touch sensitivity can mean a capacitive display is able to register even light touches and accurately distinguish between multiple touch points (multi-touch). Increasing the touch suppression generally decreases the touch sensitivity, which can require a stronger or more distinct touch signal for an event to be registered, thereby leading to the suppression of more touch events. This can be useful for rejecting unintended touch contacts, for example, grip touches and palm touches. In contrast, decreasing the touch suppression generally increases the touch sensitivity, which can allow weaker or less distinct touch signals to be registered, thereby leading to the suppression of fewer touch events. This can improve responsiveness in scenarios where sensor signals might be naturally lower.

The device may evaluate (e.g., classify) a touch contact to determine if it represents an intended touch contact or an unintended touch contact. For example, a touch suppression algorithm (e.g., grip suppression algorithm, palm rejection algorithm) may be implemented on the device to identify and filter the unintended touch contacts from the intended touch contacts. Through identification and filtering, the unintended touch contacts can be suppressed (e.g., rejected, ignored) to prevent the device from registering touch contacts that are not intended as touch inputs by a user as touch events. In this way, user experience is improved, and accidental actions can be prevented.

A main challenge in differentiating intended and unintended touch contacts is the similarity of the signal characteristics between them. This similarity can result in a false suppression of intended touches, which can cause users to perceive suboptimal touch responsiveness, especially when the device is trying to suppress unintended touches based on limited sensor information. Although touch suppression can perform well for many users and use conditions, it can sometimes falsely suppress intended touches due to changes in the sensor signals. In this way, some current touch suppression techniques may fail to adequately differentiate intended touch contacts from unintended touch contacts. To address this and other challenges, techniques and apparatuses are described for context-adaptive touch suppression adjustment.

### Operating Environment

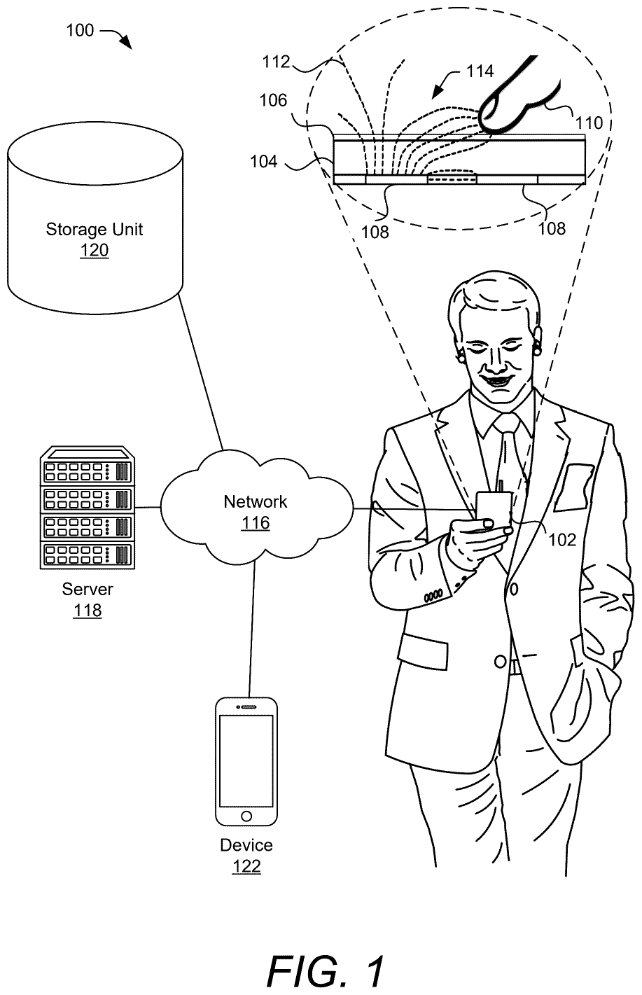

FIG. 1 illustrates an example data processing environment 100 in which aspects of context-adaptive touch suppression adjustment can be implemented. The data processing environment 100 includes an electronic device 102 (e.g., a smartphone), which is configured to view and/or manipulate data, receive phone calls, send text messages, and connect to the internet via cellular networks. The electronic device 102 includes an interface or system (e.g., touch system 114) that is configured to detect a user's touch by a conductive object (e.g., a finger 110). In various aspects, the touch system 114 includes a touch screen 104. In this example, the touch screen 104 is a capacitive display, which includes an array of sensors 108 underlying a conductive region of the touch screen 104. In this disclosure, a finger 110 may represent one or more of a touch input via a human body, a touch input via a stylus, a touch input via another means of making a touch contact, and the like. The use of “touch contact” refers to a broader mechanism or system by which a user provides interaction data to an electronic device through its touch-sensitive surface.

A user may install a screen protector 106 on the electronic device 102. The screen protector 106 may be disposed above sensors 108 of the touch screen 104. The screen protector 106 can protect the touch screen 104 from damage and/or provide other additional benefits. The screen protector 106, however, may reduce the performance of the underlying touch screen 104. This can occur because an added layer of material between the touch screen 104 and the conductive object (e.g., finger 110) can make it more difficult for the electronic device 102 to detect and/or identify a touch contact using the touch screen 104. For example, depending on the material and thickness of the screen protector 106 installed on the touch screen 104, the screen protector 106 can reduce sensor signal strength. This reduction can impact the touch suppression of the device, impact touch recognition, and degrade the device's touch performance (e.g., touch contact not recognized due to low signal strength), which can interfere with the ability of the user to interact with the device through touch contacts.

During operation, the touch screen 104 generates an electric field 112 using at least a subset of the sensors 108. Another subset of the sensors 108 measures capacitance to detect the finger 110. In one example, the capacitance represents a mutual capacitance between a transmitting sensor and a receiving sensor. In this case, the subset of transmitting sensors can represent different sensors than the subset of receiving sensors. In another example, the capacitance represents a self-capacitance measured by a sensor that generates the electric field 112 and measures the capacitance to detect the finger 110. In this case, the subset of transmitting sensors and the subset of receiving sensors can represent a same subset of sensors 108. When the user does not perform a touch contact, the capacitance can be at a baseline level. The capacitance can change relative to the baseline level while the user performs a touch contact, as further described below.

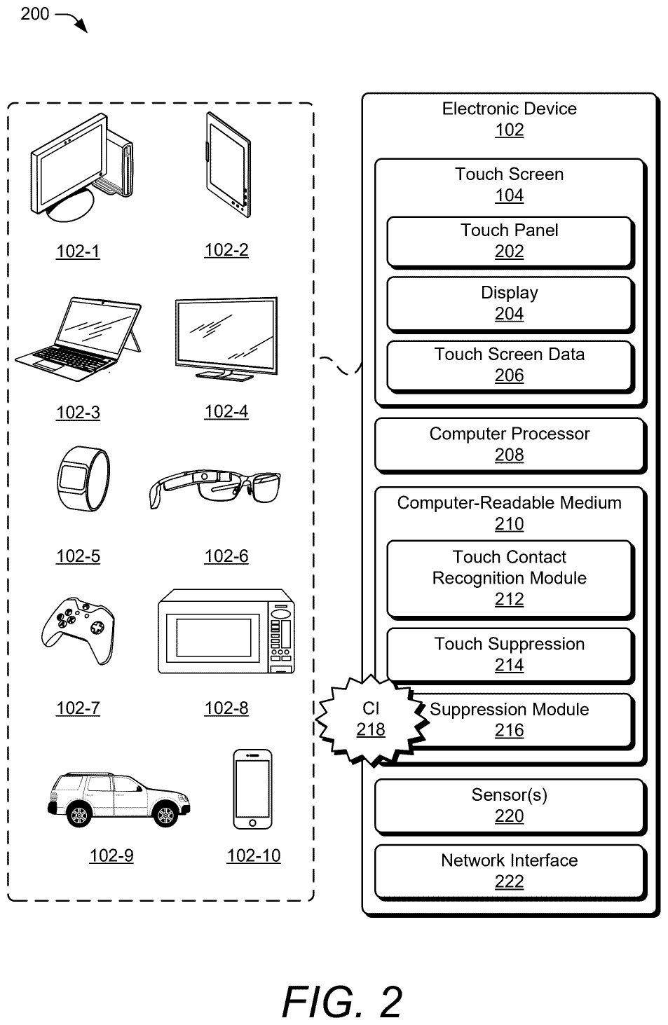

The data processing environment 100 further includes a network 116. The network 116 is a medium used to provide communications links between various devices, training systems, and computers that are connected together within the data processing environment 100. The network 116 may include connections (e.g., wire, wireless communication links, fiber optic cables). Example networks 116 can include a local-area network (LAN), a wireless local-area network (WLAN), a personal-area network (PAN), a wide-area network (WAN), an intranet, the Internet, a peer-to-peer network, a point-to-point network, a mesh network, Bluetooth®, and the like. The network 116 can communicatively couple the electronic device 102 to other entities (e.g., a server 118, a storage unit 120, another device 122). The device 122 is another example of the electronic device 102 described herein. For example, the device 122 can take the form of a smartphone, a tablet, or a laptop computer with a touch screen feature. The electronic device 102 is further described with respect to FIG. 2.

### Example Electronic Device

FIG. 2 illustrates an example electronic device 102. The electronic device 102 is illustrated with various non-limiting example devices, including a desktop computer 102-1, a tablet 102-2, a laptop 102-3, a television 102-4, a computing watch 102-5, computing glasses 102-6, a gaming system 102-7, a microwave 102-8, a vehicle 102-9, and a smartphone 102-10. Other electronic devices may also be used, for example, a home service device, a smart speaker, a smart thermostat, a baby monitor, a WLAN router, a drone, a trackpad, a drawing pad, a netbook, an e-reader, a home automation and control system, a wall display, another home appliance, and the like. The electronic device 102 can be wearable, nonwearable but mobile, or relatively immobile (e.g., desktops, appliances).

The electronic device 102 includes the touch screen 104. In this example, the touch screen 104 is an assembly of both a touch panel 202 and a display 204. The touch panel 202 includes the sensors 108 and represents an input device. As an input device, the touch panel 202 can provide a means for the user to interact and provide inputs to the electronic device 102 through touch contacts. The display 204 represents an output device, which displays content to the user. The touch panel 202 can be layered on the top of the display 204 in some implementations of the touch screen 104.

The touch panel 202 generates touch screen data 206 that correspond to the touch contacts on a continual or periodic basis. The touch screen data 206 can include raw data (e.g., touch signals) that is measured by at least a subset of the sensors (e.g., the receiving sensors). The raw data may include one or more touch coordinates, touch heat maps, durations of touch, and the like. A heat map may include amplitude data indicative of the capacitance measured by the sensors 108. The heat map can include information representative of a two-dimensional grid, with different amplitude data associated with different pairs of sensors 108 within the array. The touch coordinates can indicate a determined position of a touch contact (e.g., a position of finger 110) associated with a touch event.

The touch screen data 206 represents a temporal sequence of frames. Each frame of the touch screen data 206 represents a snapshot in time in which data is collected using the sensors 108. During time intervals when the user performs a touch contact, the touch screen data 206 includes information that enables a touch-contact recognition module 212 to detect and identify the touch contact and generate a touch event for the touch contact. The touch-contact recognition module 212 may include one or more touch recognition algorithms. During time intervals in which the user does not perform a touch contact, the touch screen data 206 can include information that indicates an absence of a touch contact. Throughout the duration of a touch contact, the touch screen 104 can provide multiple frames of the touch screen data 206 to a suppression module 216 (discussed below). In this case, values of the heat map can change over sequential frames as the touch contact is performed. In one implementation, the sequence of frames (e.g., a sequence of heat maps) may be perpetual. Alternatively, the sequence may be halted until changes are observed by the touch panel 202 that may indicate the occurrence of a touch event.

The electronic device 102 also includes a computer processor 208 and a computer-readable storage medium 210 (e.g., CRM 210), which includes memory media and/or storage media. Applications and/or an operating system (not shown) embodied as computer-readable instructions on the computer-readable medium 210 can be executed by the computer processor 208 to provide some of the functionalities described herein. As used herein, the terms “machine-readable medium,” “computer-readable medium,” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. A computer program product (CPP) may include one or more computer-readable storage media having program instructions collectively stored on the one or more computer-readable storage media, the program instructions executable (e.g., by a processor) to when executed by a processor, cause the processor to perform the operations of methods disclosed herein.

The electronic device 102 may also include one or more sensors 220 configured to measure conditions within electronic device 102 and/or conditions in an environment of electronic device 102 and provide sensor data about these conditions. For example, sensors 220 can include at least one of: (i) sensors to measure locations and/or movements of electronic device 102 (e.g., a motion sensor, a tilt sensor, a gyroscope, an accelerometer, a Doppler sensor, a Global Navigation Satellite System (GNNS) (e.g., Global Positioning System (GPS)) device, a sonar sensor, a radar device, a laser-displacement sensor, and a compass; (ii) an environmental sensor to obtain data indicative of an environment of electronic device 102 (e.g., an infrared sensor, an optical sensor, a light sensor, an ambient light sensor, a biosensor, a capacitive sensor, a touch sensor, a temperature sensor, a proximity sensor, a wireless sensor, a radio sensor, a movement sensor, a microphone, a sound sensor, an ultrasound sensor, a smoke sensor); or (iii) a force sensor to measure one or more forces (e.g., inertial forces, G-forces) acting about electronic device 102. The sensors 220 may include the sensors 108 of the touch panel 202. Sensor data can be combined using sensor fusion (e.g., by a motion sensor fusion algorithm) to achieve more-accurate determination of device position, device activity, and the like.

The computer-readable storage medium 210 can include a touch-contact recognition module 212 (e.g., one or more touch recognition algorithms), which detects and identifies different types of touch contacts as touch events. The touch-contact recognition module 212 can receive touch screen data 206 from sensors 108 of the touch panel 202 and pass information regarding the identified touch event to other applications of the electronic device 102.

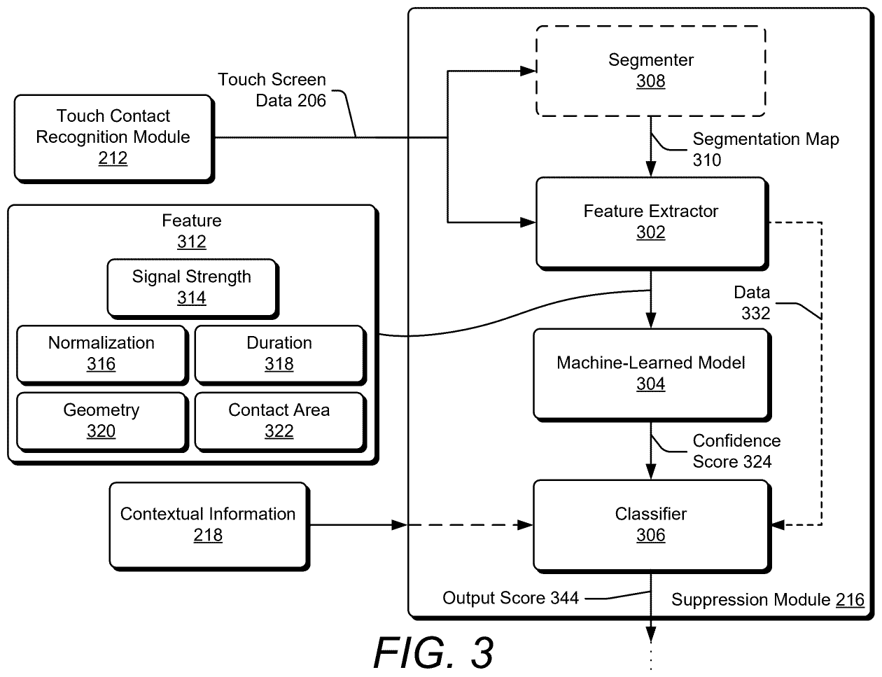

One or more algorithms may be implemented on the computer-readable medium 210 to identify and filter unintended touch contacts from intended touch contacts. In one example, a suppression module 216 performs, at least in part, context-adaptive touch suppression adjustment. The suppression module 216 (e.g., a touch suppression algorithm) can be implemented using at least one machine-learned model, as further described with respect to FIG. 3. The suppression module 216 may adjust a touch suppression strength (which may be a configurable parameter or threshold that controls the sensitivity of touch event detection), for example by adjusting a touch suppression 214 that modifies a sensitivity of the touch system 114 to register a touch contact (e.g., a tap) as a touch event. For example, the suppression module 216 may adjust a grip suppression strength that focuses on touch contacts on the edges, the suppression module 216 may adjust a palm suppression strength that focuses on larger non-finger touch contacts, and the like.

The suppression module 216 may adjust the touch suppression 214 to modify the sensitivity of the touch system 114 using data (e.g., contextual information (CI) 218) provided by the device (e.g., processor 208, sensors 220, audio manager) and related to a contextual state of the electronic device. The contextual state may encompass a physical state of the electronic device. The contextual information 218 may describe the electronic device through application programming interfaces (APIs). The contextual information 218 may include at least one of an orientation of the device (e.g., touch screen orientation relative to the user), a grounding condition, a handheld status, a position status (e.g., device position), an activity, information from inertial measurement unit sensors or other sensors, a usage status, an audio mode, a touch setting, a screen user interface (UI), a home screen activation, a keyboard activation, the presence (or absence) of a screen protector, whether a display of the device is visible to the user (e.g., display is covered, display is not covered), and the like. The contextual information can provide context about the device's state and operating environment, which is used in conjunction with features of the touch event to determine whether the touch is intended (e.g., whether the touch represents an intentional touch contact). The contextual state of the device can provide indications on how the user operates the electronic device and hence the likelihood of the presence of certain grip, palm, and other events relevant to identifying and filtering unintended touch contacts from intended touch contacts. In this way, the touch suppression 214 is dynamically selected based on received contextual information to change touch performance and provide a more robust and consistent user experience across varying operating conditions and usage scenarios.

In implementations, the suppression module 216 may determine that a first touch suppression associated with identifying intentional touch contacts (e.g., intended touch contacts) is suboptimal based on the received contextual information 218 and select a second touch suppression that is more appropriate based on the received contextual information. For example, the suppression module 216 may determine that a first touch suppression associated with identifying intentional touch contacts is suboptimal based on determining that a signal strength associated with the touch event is below a predefined level. The second touch suppression can increase or decrease a touch sensitivity for recognizing subsequent touch contacts as touch events to improve touch performance on the device. In some cases, the suppression is adjusted to decrease the probability of false detections (e.g., detecting unintended touches as touch events). The dynamic adjustment of touch sensitivity (e.g., touch suppression) based on contextual information 218 can provide the user with a consistent experience interacting with the electronic device 102 using touch contacts (e.g., touch-based gestures) in many different use situations.

The electronic device 102 can also include a network interface 222 for communicating data over a network 116 (e.g., a wired network, a wireless network, an optical network). In this way the electronic device 102 can communicate with the server 118, the storage unit 120, and/or the device 122. In some implementations, one or more of the server 118, the storage unit 120, and/or the device 122 can assist with context-adaptive touch suppression adjustment. For example, the server 118 may include one or more graphic processing units (GPUs) for training one or more machine-learned models of the electronic device 102 that perform an implementation of context-adaptive touch suppression adjustment. A database of the storage unit 120 may be or include information associated with context-adaptive touch suppression adjustment. Generally, certain operations are described as occurring at a certain component or location in an implementation. The locality of such operations is not intended to be a limit to the illustrative implementations. Any operation described herein as occurring at or performed by a particular component (e.g., the suppression module 216) can be implemented in such a manner that one component-specific function causes an operation to occur or be performed at another component (e.g., at a local or remote machine-learning (ML) or natural language processing (NLP) engine).

### Context-Adaptive Touch Suppression Adjustment

FIG. 3 illustrates an example suppression module 216 utilized by an electronic device 102 to perform aspects of context-adaptive touch suppression adjustment. In the depicted configuration, the suppression module 216 includes at least one feature extractor 302, at least one machine-learned model 304, and at least one classifier 306. In some implementations, one or more of the feature extractor 302, machine-learned model 304, or the classifier 306 may be optional. The machine-learned model 304 may be coupled between the feature extractor 302 and the classifier 306. The classifier 306 can also be directly coupled to the feature extractor 302. Other implementations are also possible in which the feature extractor 302, the machine-learned model 304, and the classifier 306 are implemented as a single machine-learned model.

The suppression module 216 can optionally include at least one segmenter 308. In the implementations of FIG. 3, the feature extractor 302 can be coupled between the segmenter 308 and the machine-learned model 304. Other implementations are also possible in which the functionality of the segmenter 308 is incorporated within the feature extractor 302. During operation, the segmenter 308 (if implemented) and the feature extractor 302 accept the touch screen data 206 provided by the sensors 108 of the touch panel 202.

As discussed above, the touch screen data 206 can include a heat map. The segmenter 308 processes the touch screen data 206 to define a region in which the touch contact occurs on the touch screen 104. The segmenter 308 provides this information to the feature extractor 302 as a segmentation map 310. In general, the segmentation map 310 provides additional context about the heat map for use by the feature extractor 302. In some implementations, the segmentation map 310 can indicate whether or not a touch event occurs within a predetermined region that can facilitate context-adaptive touch suppression adjustment. This predetermined region may represent an area of the touch screen 104 in which the sensors 108 have relatively uniform responses.

The feature extractor 302 analyzes the touch screen data 206, using the segmentation map 310 if available, to generate features 312. In some implementations, the feature extractor 302 monitors all touch events detected by the touch screen 104 and produces a set of features 312 for each touch event. As used herein, a touch event generally refers to a situation in which the user interacts with the touch screen 104 to provide touch input via a touch contact (e.g., a touch-based gesture).

Different usage scenarios and environmental factors can affect touch signal characteristics—the measurable attributes and properties of the electrical signals generated by a device's touch-sensitive input system when a physical touch contact occurs on the touch surface of the capacitive display. These touch signal characteristics provide information about the nature and intensity of the touch. The features 312 represent a collection of the measurable characteristics or attributes derived from the raw sensor signals (e.g., touch screen data 206) generated by a touch contact on a touch-sensitive surface. These features provide specific information about the nature, intensity, and spatial properties of the touch contact, which enables the device's systems to interpret and classify the touch event. Example features 312 include a signal strength 314 associated with the touch event, a signal strength normalization coefficient 316, a duration 318 associated with the touch event, a geometry 320 associated with the touch event, and/or a contact area 322 associated with the touch event. The features 312 can vary significantly due to different use situations, device conditions, and external factors. The analysis and dynamic adjustment based on these characteristics are employed by the device's systems and algorithms (e.g., machine learning classifiers) to differentiate between intended user interactions and unintended contacts (e.g., grip touches, palm touches).

The signal strength 314 can indicate an amount of capacitance detected by the touch screen 104. The signal strength 314 associated with the touch event can be an indicator of the magnitude or amplitude of the electrical signal detected by the touch sensors. Variations in signal strength can be influenced by factors, for example, grounding conditions of the device, the presence and characteristics of a screen protector, or the type of object that contacted the capacitive display. The signal strength normalization coefficient 316 can be a derived value applied to signal strength features to account for variations across different hardware configurations or environmental conditions, allowing for consistent processing by algorithms. The signal strength normalization coefficient 316 may be output by an algorithm module, described below. The duration 318 of the touch event can indicate a duration (e.g., length of time) a conductive object (e.g., finger 110) is in contact with the touch screen 104 to perform a touch contact (e.g., during a touch event). The geometry 320 associated with the touch event can describe the geometry (e.g., shape, form) of the touch contact on the touch screen 104 by the conductive object (e.g., finger 110). More specifically, the geometry 320 represents a shape that the finger 110 makes while in contact with the touch screen 104. The contact area 322 associated with the touch event can indicate the size of the region on the touch screen 104 over which a touch contact (or a portion of the touch contact) occurs.

These features 312 may be extracted by a feature extractor module (e.g., feature extractor 302) from raw touch screen data (e.g., touch screen data 206) and may be subsequently provided as input to a classification algorithm (e.g., classifier 306, machine learning classifiers), which utilize these features 312 to determine the likelihood that a touch event represents a user input (e.g., an intended touch contact or an unintended user contact).

The machine-learned model 304 can represent a trained deep learning model. In general, the machine-learned model 304 analyzes one or more features 312 associated with a touch event and maps the characteristics to one or more confidence scores 324. For instance, the machine-learned model 304 generates a confidence score 324 to indicate a likelihood that a feature 312 of a corresponding frame of a touch event is indicative of an intended touch contact with the touch screen. The confidence score 324 represents a confidence level at which the machine-learned model 304 determines the intended touch contact with the touch screen. The machine-learned model 304 can include a suite of networks that can be individually selected according to the type of electronic device 102 and/or touch screen 104 used.

The classifier 306 may in addition, or separately, compute a refined determination of an intended touch contact (or an unintended touch contact with the touch screen) using contextual information 218 related to a contextual state of the electronic device 102. For example, the classifier 306 may output an output score (e.g., output score 344) indicative of the likelihood that the touch event represents a user input (e.g., an intended touch contact or an unintended user contact). In implementations, the likelihood of the touch event being a user input is a likelihood that the touch event is an intended touch contact or an unintended touch contact.

As discussed above, the contextual information 218 may include at least one of an orientation of the electronic device 102, a grounding condition of the electronic device 102, a handheld status of the electronic device 102, a position status of the electronic device 102, an activity of the electronic device 102, information from inertial measurement unit sensors or other sensors, a usage status of the electronic device 102, an audio mode of the electronic device 102, a touch setting of the electronic device 102, a screen user interface (UI) of the electronic device 102, a home screen activation of the electronic device 102, a keyboard activation of the electronic device 102, and the like.

The orientation of the electronic device 102 (e.g., orientation of the touch screen) may be determined relative to the user. For example, a landscape orientation or a portrait orientation. Utilization of orientation contextual information may be used to adjust the touch suppression based on the electronic device being in that orientation, thereby enhancing responsiveness for inputs typically associated with (e.g., commonly performed in) that orientation.

The grounding condition may indicate whether the electronic device 102 has some form of grounding. Example grounding conditions include a port connection status of the electronic device, a handheld status of the electronic device, and/or a signal strength associated with a touch event. The port connection status indicates whether or not a port of the electronic device 102 is connected. Example ports can include a universal serial bus (USB) port or a power port of the electronic device 102. The handheld status may indicate whether the electronic device 102 is being held by the user, whether the electronic device 102 is not being held by the user, and/or whether the electronic device 102 is being held in a specific grip (e.g., palm grip). The handheld status can be determined in a variety of different ways.

In aspects, the electronic device 102 includes a motion sensor, which enables the electronic device 102 to determine motion-related contextual information (e.g., if the motion of the electronic device 102 corresponds to the user holding the electronic device 102, if the motion of the electronic device 102 corresponds to the electronic device 102 in a moving vehicle, if the motion of the electronic device 102 corresponds to a stationary status of the electronic device 102, a geolocation of the electronic device 102). The position status may be received from a motion sensor fusion algorithm running on the electronic device. In another example, the electronic device 102 can detect a grip of the user using a sensor (e.g., a capacitive sensor). By detecting the user's grip, the electronic device 102 can suppress unintended touch events that can occur near the edges of the touch screen 104 due to the user's grip. Based on determining that the electronic device is being held by a user, touch suppression can be adjusted to prevent unintended grip touches. Further, based on identifying a palm touch or a grip touch, touch suppression can be increased. The position status (e.g., device position) may indicate a position of the electronic device 102. Example position statuses include the device placed on a table with a display facing upward, the device placed on a table with a display facing downward, the device placed in a clothing pocket, and the device placed in a bag.

The audio modes may include at least one of a voice call mode, a speakerphone mode, or a silent mode. Adjusting the touch suppression based on a specific audio mode may change touch performance for user interactions during that audio mode. For example, increasing the touch suppression when the electronic device is in a voice call mode may mitigate unintended touches.

The classifier 306 uses the contextual information 218 of the electronic device 102 to further interpret the confidence score 324 and/or data 332 passed by the feature extractor 302. The data 332 can include the touch screen data 206 or a processed version thereof. When the electronic device 102 is grounded, the touch screen data 206 (and/or the data 332) may be more reliable. As such, the classifier 306 can utilize the grounding condition to further adjust the confidence score 324 or a detection criterion based on the grounding condition. For example, the classifier 306 can increase the confidence score 324 or relax the detection criterion based on the grounding condition indicating that the electronic device 102 has some form of grounding (e.g., a port is connected, the electronic device 102 is being held by the user). Alternatively, the classifier 306 can decrease the confidence score 324 and/or increase a strictness of the detection criterion based on the grounding condition indicating that the electronic device 102 is not grounded.

### Dynamic Feature Normalization

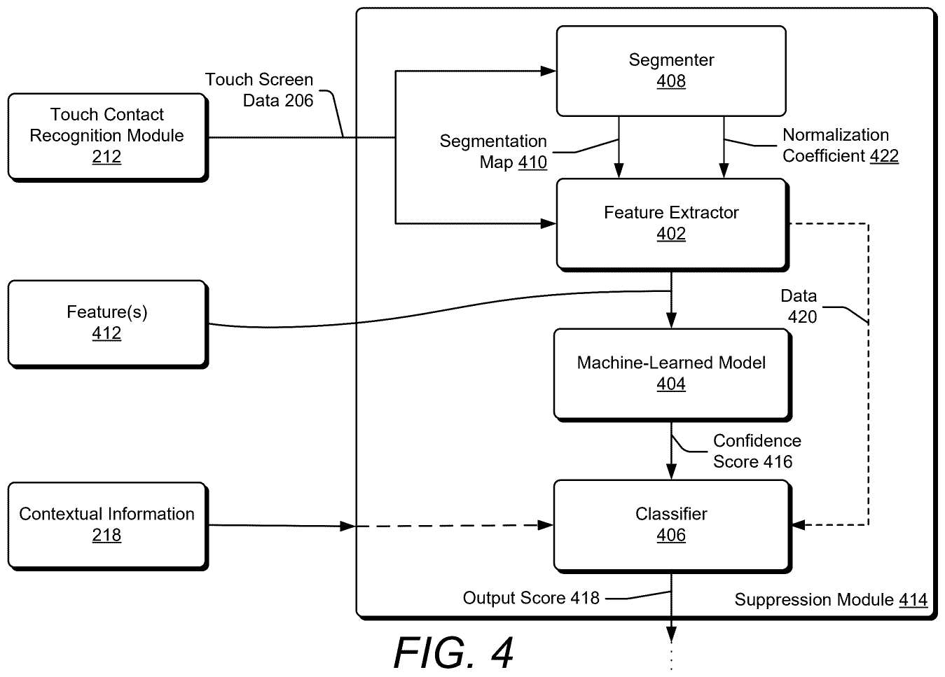

FIG. 4 is a diagram that illustrates an example implementation 400 of context-adaptive touch suppression adjustment, which includes dynamic feature normalization where features are normalized for machine learning classifiers.

In portions of the following discussion, reference can be made to the example data processing environment 100 of FIG. 1 and/or to entities or processes as detailed in FIGS. 2 and 3, reference to which is made for example only. Implementation 400 is similar to implementation 300 illustrated in FIG. 3 and described above, except as detailed below. Thus, implementation 400 includes feature extractor 402, machine-learned model 404, classifier 406, segmenter 408, segmentation map 410, features 412, suppression module 414, confidence score 416, output score 418, and data 420 passed by the feature extractor.

Devices may utilize different hardware (e.g., a screen protector present or absent), different firmware, different device positions, different grounding conditions, and the like. In one example, an edge tap signal strength (e.g., touch peak strength) from a first device configuration that includes a low ground condition and a screen protector 106 may be substantially lower than an edge tap signal strength from a second device configuration that includes a good grounding condition without a screen protector. Further examples of different configurations include: (a) USB-connected, handheld, and with no screen protector fitted; (b) not USB-connected, on table, and with no screen protector fitted; (c) USB-connected, on table, and with no screen protector fitted; (d) not USB-connected, handheld, and with no screen protector fitted; (e) USB-connected, handheld, with a screen protector fitted; (f) USB-connected, on table, with a screen protector fitted; (g) not USB-connected, on table, with screen protector fitted; and (h) not USB-connected, handheld, with a screen protector fitted.

These differences can result in variations in the raw sensor signals (e.g., touch screen data 206) generated by a touch contact on a touch-sensitive surface. For example, a device placed on a non-conductive surface or without a stable ground connection may yield lower touch signal strengths than when held by a user or connected via a cable. The variances can lead to inconsistencies in the performance of touch suppression algorithms, particularly when the touch suppression algorithms utilize features derived from raw sensor signals (e.g., signal strength) as an input. As a result, features 412 used by the machine learning classifier (e.g., classifier 406) may vary significantly based on hardware/firmware differences and thus, the output of the classifier 406 may not be configured for all use situations.

To accommodate the classifier 406 for different device models, features 412 that are dependent on the different hardware components for each device model may be normalized by applying a dynamic feature normalization to at least one feature 412. The dynamic feature normalization may be based at least in part on contextual information 218 that is related to a contextual state of the electronic device 102 (e.g., a USB-connected grounding condition, a not USB-connected grounding condition, another grounding condition, a handheld position, an on a table position, an in a clothing pocket position, an in a bag position, the presence or absence of a screen protector, and the like). Applying the dynamic feature normalization to the set of features provided to the machine learning classifier may include monitoring a trend of a peak strength registered from the touch event. In this way, the set of features 412 is adjusted for variations in touch signal characteristics.

Providing a way to adjust the normalization coefficient when the signal strength from the touch event changes may compensate the features impacted by the low signal strength to adapt to different use situations. For example, the peak touch sensor strength of a touch contact may contribute to the likelihood of a touch event being classified as an intended touch contact or an unintended touch contact (e.g., a grip touch, a palm touch). The characteristic of the peak touch sensor strength is, however, dependent on the hardware/firmware design, and the peak touch sensor strength value can range from a few hundred to a few thousand under good grounding conditions.

To generate a suppression module 414 that can accommodate different devices, dynamic feature normalization may be performed by applying a preconfigured normalization coefficient 422 to normalize strength-dependent features (e.g., at least one of an edge slope normalization, a peak amplitude normalization, or an average amplitude normalization). The normalization coefficient 422 may be device model dependent. The dynamic feature normalization may adjust the set of features for variations in touch signal characteristics based on a grounding condition of the electronic device. The grounding condition may include a port connection status or a handheld status. The dynamic feature normalization may adjust the set of features for variations in touch signal characteristics based on presence or absence of a screen protector coupled to the capacitive touch screen.

Normalizing the values of the strength dependent features using the normalization coefficient 422 may allow a universal machine-learned model to be used across different device models that are equipped with different touch components (e.g., hardware, firmware). In this way, the contextual information 218 is used to normalize features 412 used by the machine learning classifier (e.g., classifier 406) and dynamically adapt the operation of the touch-sensitive input system. This allows for a more-robust and consistent touch experience by compensating for variations in touch signal characteristics that occur under different real-world conditions and supporting improved accuracy in touch event classification across various operating conditions.

In some aspects, the system monitors touch signal strength over time. Upon detecting a persistent reduction in signal strength characteristic of a screen protector being applied, the system can automatically adjust a touch sensitivity parameter, equivalent to a “screen protector mode,” to compensate for the signal loss without requiring user interaction.

### Example Use Cases

In a first example use case, the device is in a voice call mode. To minimize false touches (e.g., unintended touches) during a phone call, the touch sensitivity may be lower. For example, when the device is in a phone call, the touch sensitivity near the edges of the touch screen 104 may be lower and as the finger 110 of the user taps on the touch screen 104, the touch panel 202 may become less responsive. In the voice call mode use case, the suppression strength is adjusted higher. In an example, the grip suppression strength is adjusted higher (e.g., maxed) to minimize unintended touch caused by the holding hand/fingers and palm suppression strength is not adjusted because the user should be allowed to interact with the dialer UI. Further, contacts from the ear and/or the cheek of the user may be suppressed by an ear/cheek suppression algorithm.

In a second example use case, the device is in a clothing pocket of a user. In this state, the suppression strength is adjusted higher to reduce touch sensitivity and prevent false touch events. In an example, the grip suppression strength and the palm suppression strength are adjusted higher (e.g., maxed). The device may be configured with a minimal touch sensitivity to prevent unintended touches from objects (e.g., coins, keys, fingers, hands) while in the pocket. In this use case, if the device is placed in a pocket facing towards the body of the user, the device should not easily register touch events when woken up by a notification. In this use case, if the device is placed in a pocket facing away from the body of the user, the device should not easily register touch events when woken up by a notification, even if a hand is placed over the display.

In a third example use case, the device is in a bag (e.g., a purse, a backpack). In this state, the suppression strength is adjusted higher to reduce touch sensitivity and prevent false touch events. In an example, the grip suppression strength and the palm suppression strength are adjusted higher (e.g., maxed). When in a bag, the device may be configured with a minimal touch sensitivity to prevent unintended touches from other conductive objects in the bag. In this use case, where the device is placed in a bag and the bag is carried around, the device should not easily register touch events when woken up by a notification.

In a fourth example use case, the device is static (e.g., stationary, placed on a table) with the main display of the device facing up. In this state, the suppression strength is adjusted lower to increase touch sensitivity. This is because, when a device is placed face up on a table, there is a less chance of unintended touch on the edges. In this way, stationary devices usually do not associate with unintended touches from a hand grip. Stationary devices also experience lower grounding (lower sensor signals), for example when not USB-connected. As a result, the suppression strength can be relaxed to increase touch sensitivity. In an example, the grip suppression strength is adjusted lower (e.g., relaxed, decreased, reduced) and palm suppression strength is not adjusted. In another example, palm suppression strength is adjusted lower to minimize false palm suppression and boost touch sensitivity. The lower suppression strength may improve the touch sensitivity for edge touches, which can compensate for the low signal from low ground condition when the electronic device is in this use case. In comparison with handheld usage where normal touch responses are expected when using a finger to lightly tap the edges of a phone while holding it with a hand, using a finger to lightly tap the edges of the phone while it is placed on a table and not USB connected, there should be no performance difference.

In a fifth example use case, the device is static (e.g., stationary, placed on a table) with the main display of the device facing down. In this state, the suppression strength is adjusted higher to reduce touch sensitivity and prevent false touch events. In an example, the grip suppression strength and the palm suppression strength are adjusted higher (e.g., maxed). The device may be configured with at least a minimal touch sensitivity to prevent false touches on a conductive object/surface (e.g., a conductive table surface). In this use case, if the screen of the device is turned off and the device is placed on a conductive surface, the device should not register any touch events when woken up by a notification.

In a sixth example use case, the device is in an on-screen keyboard mode. In the on-screen keyboard mode, touch sensitivity near the edges of the touch screen 104 is higher (suppression strength is lower) when on-screen keyboard is visible to improve responsiveness of the edge keys. Thus, when the on-screen keyboard is visible, the touch responses near the edges become more sensitive. For example, the ‘p’, ‘q’, and the ‘backspace’ keys can still be registered when tapping on the very edge of the touch screen 104. Additional use cases may include the device being handheld by left hand, the device being handheld by right hand, the device secured to a holder on a car, etc.

### Example Methods

This section illustrates example methods, which may operate separately or together in whole or in part. The methods are illustrated in the Drawings as sets of operational blocks that specify operations performed but are not necessarily limited to the order or combinations shown for performing the operations. Further, one or more of the operations may be repeated, combined, reorganized, reordered, or linked to provide a wide array of additional and/or alternate methods. In portions of the following discussion, reference may be made to the example data processing environment 100 and electronic device 102 of FIG. 1 or to entities or processes as detailed in other figures, reference to which is made for example only. The techniques (e.g., methods) are not limited to performance by one entity or multiple entities operating on one device.

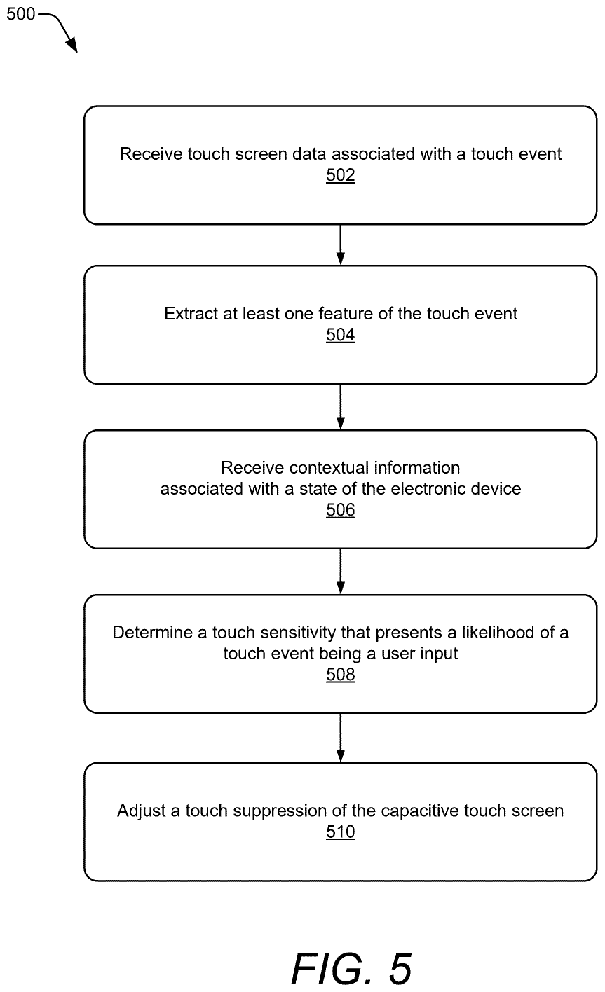

FIG. 5 illustrates an example method 500 for context-adaptive touch suppression adjustment, performed by an electronic device 102. The electronic device 102, which can be any of the devices depicted in FIG. 2, includes a capacitive touch screen 104 and a computer processor 208. The processor 208, executing instructions from a computer-readable medium 210 (e.g., instructions within a suppression module 216 or a touch-contact recognition module 212), is configured to perform the operations of method 500.

At operation 502, the processor 208 receives touch screen data 206 associated with a touch event on the capacitive touch screen 104 of the electronic device 102. The touch screen 104, which may include a touch panel 202 with sensors 108, generates the touch screen data 206 when a conductive object, such as a user's finger 110, makes contact with its surface.

At operation 504, the processor 208, potentially using a feature extractor 302, extracts at least one feature 312 of the touch event from the touch screen data 206. The feature 312 can include, for example, a signal strength 314, a duration 318, a geometry 320, or a contact area 322 associated with the touch event.

At operation 506, the processor 208 receives contextual information 218 associated with a state of the electronic device 102. This information can be sourced from various components, such as one or more sensors 220 (e.g., an accelerometer, a gyroscope), a network interface 222, or the operating system, which provide data regarding the device's orientation, grounding condition, handheld status, and/or audio mode.

At operation 508, the processor 208 determines a touch sensitivity indicative of a likelihood of the touch event being a user input. This determination may be based on the extracted feature 312 and the received contextual information 218. In some implementations, this operation is performed by a classifier 306, which may be part of a machine-learned model 304, that processes the feature and contextual data to generate an output score 344 representing the touch sensitivity.

At operation 510, the processor 208 adjusts, based on the determined touch sensitivity, a touch suppression 214 of the capacitive touch screen 104. This adjustment, which can be managed by the suppression module 216, modifies how subsequent touch events are identified as intentional touch contacts, for example, by increasing or decreasing the touch sensitivity of the electronic device 102. This dynamic adjustment allows the system to change touch performance across various usage scenarios. In implementations, the touch suppression of the capacitive touch screen for identifying intentional touch contacts for the electronic device is adjusted such that the touch sensitivity of the electronic device for detecting subsequent touch contacts is increased. In implementations, the touch suppression of the capacitive touch screen for identifying intentional touch contacts for the electronic device is adjusted such that the touch sensitivity of the electronic device for detecting subsequent touch contacts is decreased.

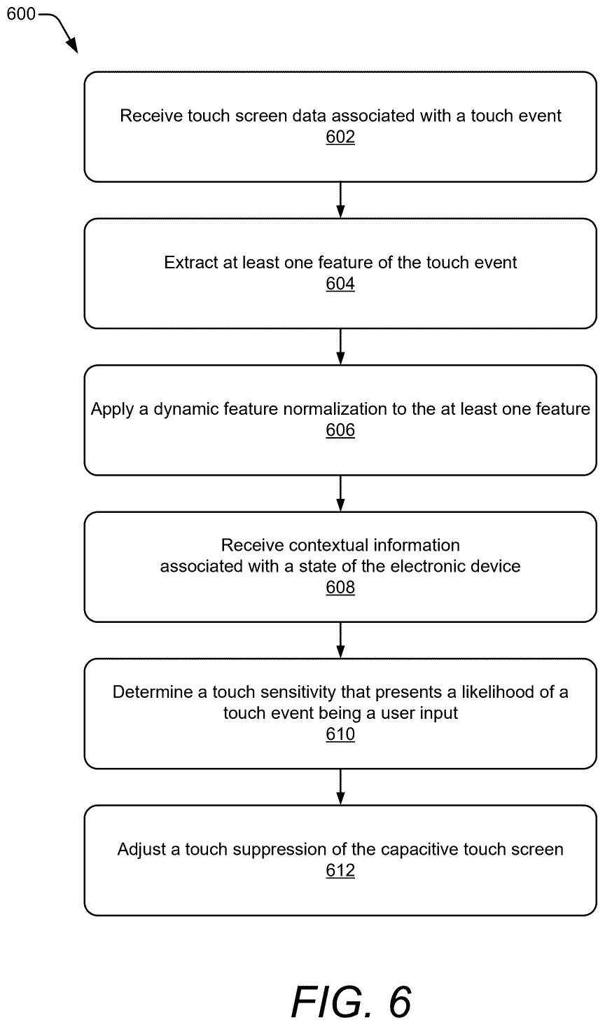

FIG. 6 illustrates an example method 600 for context-adaptive touch suppression adjustment, which may be performed by an electronic device 102. The electronic device 102, which can be one of the devices depicted in FIG. 2, can include a computer processor 208 and a computer-readable medium 210 that stores modules (e.g., a suppression module 216). The computer processor 208 can execute instructions associated with the modules to perform the operations of method 600.

At operation 602, the processor 208 receives touch screen data 206 associated with a touch event on a capacitive touch screen 104 of the electronic device 102. The capacitive touch screen 104, which may include a touch panel 202 with an array of sensors 108, generates the touch screen data 206 in response to a touch contact.

At operation 604, the processor 208, which may utilize a feature extractor 302, extracts at least one feature 312 of the touch event from the touch screen data 206.

At operation 606, the processor 208 applies a dynamic feature normalization to the at least one feature 312. This may be performed by the feature extractor 302 or a dedicated normalization module, which adjusts the feature 312 based on a preconfigured or dynamically determined normalization coefficient 422 to account for variations in touch signal characteristics.

At operation 608, the processor 208 receives contextual information 218 associated with a state of the electronic device 102. The processor 208 may obtain this information from various sources (e.g., sensors 220, a network interface 222, the operating system), which provide data regarding the device's grounding condition, position, and/or operational mode.

At operation 610, the processor 208 determines that a first touch suppression is suboptimal and selects a second touch suppression based on the normalized feature and the contextual information 218. This determination, which may be performed by a classifier 306, establishes a touch sensitivity indicative of a likelihood of the touch event being a user input. The classifier 306 may be implemented as part of a machine-learned model 304.

At operation 612, the processor 208 adjusts a touch suppression 214 of the capacitive touch screen 104 based on the determined touch sensitivity and the selected second touch suppression. The suppression module 216 can manage this adjustment, modifying how subsequent touch events are identified as intentional touch contacts. In implementations, the touch suppression of the capacitive touch screen for identifying intentional touch contacts for the electronic device is adjusted by increasing the touch sensitivity of the electronic device for detecting subsequent touch contacts. In implementations, the touch suppression of the capacitive touch screen for identifying intentional touch contacts for the electronic device is adjusted by decreasing the touch sensitivity of the electronic device for detecting subsequent touch contacts.

In implementations, a method (e.g., method 500, method 600) is performed by an apparatus including a capacitive touch screen and a processor. In implementations, the method (e.g., method 500, method 600) is performed by an apparatus that includes a processor and a computer-readable storage medium (CRM) having stored thereon instructions that, responsive to execution by the processor, cause the processor to perform the method. In implementations, a computer-program product (CPP) tangibly embodied in a non-transitory machine-readable storage medium includes instructions configured to cause the system and/or the one or more processors to perform part or all of the method (e.g., method 500, method 600).

### Example Computing System

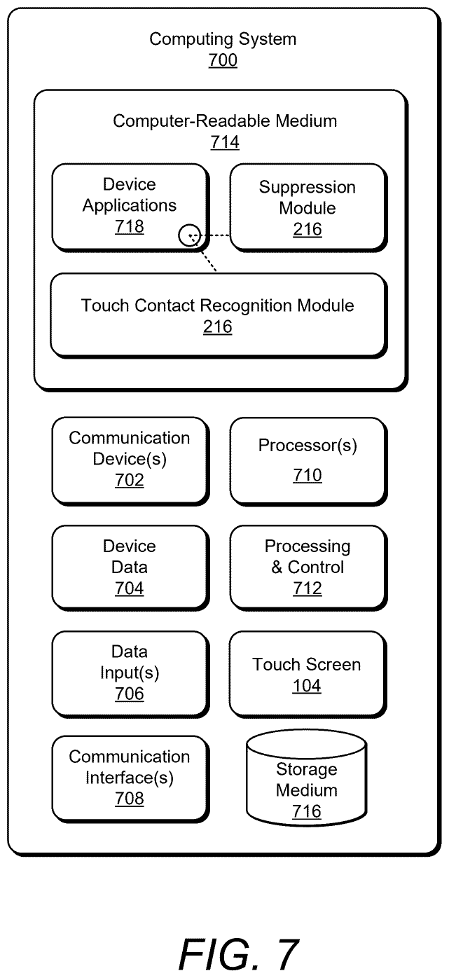

FIG. 7 illustrates various components of an example computing system 700 that can be implemented as any type of client, server, and/or electronic device as described with reference to the previous FIGS. 1-7 to implement aspects of context-adaptive touch suppression adjustment. The computing system 700 includes communication device 702 (e.g., electronic device 102) that enables wired and/or wireless communication of device data 704 (e.g., received data, data that is being received, data scheduled for broadcast, or data packets of the data). The device data 704 or other device content can include configuration settings of the computing system 700, media content stored on the computing system 700, and/or information associated with a user of the computing system 700. Media content stored on the computing system 700 can include any type of audio, video, and/or image data. The computing system 700 includes data input(s) 706 via which any type of data, media content, and/or inputs can be received (e.g., human utterances, user-selectable inputs (explicit or implicit), messages, music, television media content, recorded video content, and any other type of audio, video, and/or image data received from any content and/or data source).

The computing system 700 also includes communication interface(s) 708, which can be implemented as one or more of a serial and/or parallel interface, a wireless interface, any type of network interface, a modem, and any other type of communication interface. The communication interface(s) provide a connection and/or communication links between the computing system 700 and a communication network by which other electronic, computing, and communication devices communicate data with the computing system 700.

The computing system 700 includes processor(s) 710 (e.g., microprocessors, controllers, and the like), which process various computer-executable instructions to control operation of the computing system 700. Alternatively, or in addition, the computing system 700 can be implemented with any one or combination of hardware, firmware, or fixed logic circuitry that is implemented in connection with processing and control circuits 712. Although not shown, the computing system 700 can include a system bus or data transfer system that couples the various components. A system bus can include any one or combination of different bus structures (e.g., a memory bus, a memory controller, a peripheral bus, a USB, and/or a processor or local bus that utilizes any of a variety of bus architectures).

The computing system 700 (or the communication device(s) 702), include at least one touch screen 104, which can be a capacitive touch screen. The computing system 700 also includes a computer-readable medium 714 (e.g., one or more memory devices that enable persistent and/or non-transitory data storage, in contrast to mere signal transmission), examples of which include random access memory (RAM), non-volatile memory (e.g., any one or more of a read-only memory (ROM), flash memory, erasable programmable read-only memory (EPROM), etc.), and a disk storage device. The disk storage device may be implemented as any type of magnetic or optical storage device (e.g., a hard disk drive, a recordable, and/or rewriteable compact disc (CD), any type of a digital versatile disc (DVD), and the like). The computing system 700 can also include a mass storage medium device (storage media 716).

The techniques and apparatuses of the present disclosure may be implemented using hardware, software, firmware, or a combination thereof and may be implemented in one or more computer systems or other processing systems. Some embodiments of the present disclosure include a system including a processing system that includes one or more processors. In some embodiments, the system includes a non-transitory computer-readable storage medium containing instructions which, when executed on the one or more processors, cause the system and/or the one or more processors to perform part or all of one or more methods and/or part or all of one or more processes disclosed herein. Some embodiments of the present disclosure include a computer-program product tangibly embodied in a non-transitory machine-readable storage medium, including instructions configured to cause the system and/or the one or more processors to perform part or all of one or more methods and/or part or all of one or more processes disclosed herein.

The computer-readable medium 714 provides data storage mechanisms to store the device data 704, as well as various device applications 718 and any other types of information and/or data related to operational aspects of the computing system 700. For example, an operating system (not shown) can be maintained as a computer application with the computer-readable medium 714 and executed on the processor(s) 710. The device applications 718 may include a device manager (e.g., any form of a control application, a software application, a signal-processing and control module, code that is native to a particular device, a hardware abstraction layer for a particular device, and so on).

The device applications 718 also include any system components, engines, or managers to implement context-adaptive touch suppression adjustment. In this example, the device applications 718 may include the touch-contact recognition module 212 and the suppression module 216 of FIG. 2.

### Privacy

Throughout this disclosure, examples are described where a computing system (e.g., the electronic device, a client device, a server device, a computer, or another type of computing system) may analyze information associated with a user, for example, contextual information about the status of one or more parameters of the electronic device. Further to the descriptions above, a user may be provided with controls allowing the user to make an election as to both if and when systems, programs, and/or features described herein may enable collection of information (e.g., device sensor data, device motion, device orientation, and other operational contexts of the device as described herein), and if the user is sent content or communications from a server. The computing system can be configured to only use the information after the computing system receives explicit permission from the user of the computing system to use the data. Further, individual users may have constant control over what programs can or cannot do with the information. In addition, information collected may be pre-treated in one or more ways before it is transferred, stored, or otherwise used, so that personally-identifiable information is removed. Thus, the user may have control over whether information is collected about the user and the user's device, and how such information, if collected, may be used by the computing device and/or a remote computing system.

### EXAMPLES

In this section, examples are provided.
Example 1. A method comprising: receiving touch screen data associated with a touch event on a capacitive touch screen of an electronic device; extracting at least one feature of the touch event from the touch screen data; receiving contextual information associated with a state of the electronic device; determining, based on the feature and the contextual information, a touch sensitivity indicative of a likelihood of a touch event being a user input; and adjusting, based on the determined touch sensitivity, a touch suppression of the capacitive touch screen for identifying intentional touch contacts for the electronic device.
Example 2. The method of Example 1, wherein the likelihood of the touch event being a user input is a likelihood that the touch event is an intended touch contact or an unintended touch contact.
Example 3. The method of Example 1, wherein the feature of the touch event includes at least one of: a signal strength associated with the touch event; a signal strength normalization coefficient; a duration of the touch event; a geometry associated with the touch event; or a contact area associated with the touch event.
Example 4. The method of Example 1, wherein the contextual information associated with the state of the electronic device includes a grounding condition of the electronic device.
Example 5. The method of Example 4, wherein the grounding condition is determined based on at least one of a port connection status of the electronic device, a handheld status of the electronic device, or a signal strength associated with the touch event.
Example 5.1. The method of Example 5, wherein the port connection status indicates whether a USB port or a power port of the electronic device is connected.
Example 5.2. The method of Example 5, wherein the handheld status indicates whether the electronic device is being held by a user.
Example 5.3. The method of Example 5, wherein the handheld status is determined by a motion sensor of the electronic device.
Example 6. The method of Example 4, further comprising adjusting a normalization coefficient for features provided to a machine learning classifier, wherein the adjustment is based on the grounding condition.
Example 7. The method of Example 1, wherein the contextual information associated with the state of the electronic device includes at least one of an orientation of the electronic device or a position of the electronic device.
Example 7.1. The method of Example 7, wherein the orientation of the electronic device includes a landscape orientation or a portrait orientation.
Example 7.2. The method of Example 7, further comprising adjusting the touch suppression based on the electronic device being in a landscape orientation, thereby enhancing responsiveness for inputs typically associated with that orientation.
Example 7.3. The method of Example 7, further comprising adjusting the touch suppression based on the electronic device being in a portrait orientation, thereby configuring detection for inputs commonly performed in that orientation.
Example 7.4. The method of Example 7, further comprising determining the device position based on input from at least one motion sensor.
Example 7.5. The method of Example 7.4, wherein the at least one motion sensor includes at least one of a gyroscope or an accelerometer.
Example 7.6. The method of Example 7, wherein the position of the electronic device includes at least one of: a device placed on a table with a display facing upward; a device placed on a table with a display facing downward; a device placed in a clothing pocket; or a device placed in a bag.
Example 7.7. The method of Example 7.6, wherein the adjusting includes: decreasing the touch suppression when the device is placed on a table with the display facing upward; or increasing the touch suppression when the device is placed in a clothing pocket or a bag.
Example 7.8. The method of Example 7, further comprising: identifying a grip touch or a palm touch based on the position of the electronic device; and suppressing the grip touch or the palm touch based on the determined touch sensitivity.
Example 7.9. The method of Example 7.8, wherein suppressing the grip touch or the palm touch includes adjusting a touch suppression for a classifier that determines the likelihood of a touch event being a user input.
Example 8. The method of Example 1, wherein the contextual information associated with the state of the electronic device includes at least one of an audio mode of the electronic device or a motion of the electronic device.
Example 8.1. The method of Example 8, further comprising adjusting the touch suppression based on a specific audio mode, thereby configuring touch performance for user interactions during that audio mode.
Example 8.2. The method of Example 8, wherein the audio mode includes at least one of a voice call mode, a speakerphone mode, or a silent mode.
Example 8.3. The method of Example 8, further comprising increasing the touch suppression when the electronic device is in a voice call mode to mitigate unintended touches.
Example 8.4. The method of Example 8, wherein the motion of the electronic device includes at least one of: the device stationary; or the device moving.
Example 9. The method of Example 1, wherein the contextual information associated with the state of the electronic device includes a handheld status of the electronic device.
Example 9.1. The method of Example 9, wherein the handheld status indicates whether the electronic device is being held by a user, held in a specific grip, or not being held.
Example 9.2. The method of Example 9, further comprising adjusting the touch suppression based on determining that the electronic device is being held by a user, thereby preventing unintended grip touches.
Example 9.3. The method of Example 9, wherein adjusting the touch suppression based on the handheld status includes increasing touch suppression when a palm touch or a grip touch is identified.
Example 10. The method of Example 1, wherein adjusting the touch suppression of the capacitive touch screen further comprises: setting a touch suppression associated with identifying intentional touch contacts.
Example 11. The method of Example 1, wherein adjusting the touch suppression of the capacitive touch screen further comprises: determining that a first touch suppression associated with identifying intentional touch contacts is suboptimal based on the received contextual information; and automatically selecting a second touch suppression that corresponds to the contextual information received.
Example 12. The method of Example 11, wherein determining that the first touch suppression associated with identifying intentional touch contacts is suboptimal based on the contextual information received further comprises: determining that a signal strength associated with the touch event is below a predefined level.
Example 12.1. The method of Example 11, wherein determining that the first touch suppression is suboptimal is based on detecting a presence of a screen protector on the capacitive touch screen, and wherein the second touch suppression is selected to increase a touch sensitivity of the capacitive touch screen to compensate for the presence of the screen protector.
Example 13. The method of Example 11, wherein selecting the second touch suppression comprises: applying a dynamic feature normalization to a set of features provided to a machine learning classifier.
Example 13.1. The method of Example 13, wherein applying the dynamic feature normalization further comprises: normalizing at least one strength-dependent feature associated with the touch event using a preconfigured normalization coefficient.
Example 13.2. The method of Example 13, wherein the preconfigured normalization coefficient is device model dependent.
Example 13.3. The method of Example 13, wherein the at least one strength-dependent feature includes at least one of: an edge slope normalization; a peak amplitude normalization; or an average amplitude normalization.
Example 13.4. The method of Example 13, wherein applying the dynamic feature normalization to the set of features provided to the machine learning classifier further comprises monitoring a trend of a peak strength registered from the touch event.
Example 13.5. The method of Example 13, wherein the dynamic feature normalization adjusts the set of features for variations in touch signal characteristics based on a grounding condition of the electronic device.
Example 13.6. The method of Example 13.5, wherein the grounding condition includes a port connection status or a handheld status.
Example 13.7. The method of Example 13, wherein the dynamic feature normalization adjusts the set of features for variations in touch signal characteristics based on presence or absence of a screen protector coupled to the capacitive touch screen.
Example 14. The method of Example 11, further comprising: identifying at least one of a grip touch or a palm touch based on the touch event and the received contextual information; and suppressing the grip touch or the palm touch based on the selected second touch suppression.
Example 15. The method of Example 1, wherein the touch suppression of the capacitive touch screen is adjusted by increasing the touch sensitivity of the electronic device for detecting subsequent touch contacts.
Example 16. The method of Example 1, wherein the touch suppression of the capacitive touch screen is adjusted by decreasing the touch sensitivity of the electronic device for detecting subsequent touch contacts.
Example 17. The method of Example 1, further comprising adjusting a normalization coefficient for features provided to a machine learning classifier, wherein the adjustment is based on the contextual information received.
Example 18. The method of Example 1, wherein determining the touch sensitivity further comprises: generating, based on the feature of the touch event, a confidence score for the touch event; and applying a classifier to the confidence score and the contextual information to determine the touch sensitivity.
Example 19. The method of Example 1, wherein the feature of the touch event includes at least one strength-dependent feature; wherein the state of the electronic device is a physical state of the electronic device, wherein the contextual information further comprises at least one of: a grounding condition of the electronic device, or a presence of a screen protector coupled to the capacitive touch screen; wherein the method further comprises: applying a dynamic feature normalization to the at least one strength dependent feature based on the contextual information to generate at least one normalized feature; and wherein the touch sensitivity is determined based on the at least one normalized feature and the contextual information.
Example 20. An apparatus comprising: a capacitive touch screen configured to generate touch screen data; and a processor configured to: receive touch screen data associated with a touch event on the capacitive touch screen; extract at least one feature of the touch event from the touch screen data; receive contextual information associated with a state of the electronic device; determine, based on the feature and the contextual information, a touch sensitivity indicative of a likelihood of a touch event being a user input; and adjust, based on the determined touch sensitivity, a touch suppression of the capacitive touch screen for identifying intentional touch contacts for the electronic device.
Example 21. A computer-readable storage medium having stored thereon instructions that, responsive to execution by a processor, cause an electronic device to: receive touch screen data associated with a touch event on a capacitive touch screen of the electronic device; extract at least one feature of the touch event from the touch screen data; receive contextual information associated with a state of the electronic device; determine, based on the feature and the contextual information, a touch sensitivity that indicative of likelihood of a touch event being a user input; and adjust, based on the determined touch sensitivity, a touch suppression of the capacitive touch screen for identifying intentional touch contacts for the electronic device.

### Construction

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). The use of the articles “a,” “an,” and “the” are meant to be interpreted as referring to the singular as well as the plural, unless the context clearly dictates otherwise.

### CONCLUSION

Although implementations of techniques and apparatuses relate to the implementation of context-adaptive touch suppression adjustment have been described in language specific to features and/or methods, it is to be understood that the subject of the appended claims is not necessarily limited to the specific features or methods described. Rather, the specific features and methods are disclosed as example implementations of techniques and apparatuses relate to the implementation of context-adaptive touch suppression adjustment.

What is claimed is:

1. A method comprising:
receiving touch screen data associated with a touch event on a capacitive touch screen of an electronic device;
extracting at least one feature of the touch event from the touch screen data;
receiving contextual information associated with a state of the electronic device;
determining, based on the feature and the contextual information, a touch sensitivity indicative of a likelihood of a touch event being a user input; and
adjusting, based on the determined touch sensitivity, a touch suppression of the capacitive touch screen.

2. The method of claim 1, wherein the likelihood of the touch event being a user input is a likelihood that the touch event is an intended touch contact or an unintended touch contact.

3. The method of claim 1, wherein the feature of the touch event includes at least one of:
a signal strength associated with the touch event;
a signal strength normalization coefficient;
a duration of the touch event;
a geometry associated with the touch event; or
a contact area associated with the touch event.

4. The method of claim 1, wherein at least one of the feature of the touch event or the contextual information associated with the state of the electronic device includes a grounding condition of the electronic device.

5. The method of claim 4, wherein the grounding condition is determined based on at least one of a port connection status of the electronic device, a handheld status of the electronic device, or a signal strength associated with the touch event.

6. The method of claim 4, further comprising:
adjusting a normalization coefficient for features provided to a machine learning classifier, wherein the adjustment is based on the grounding condition.

7. The method of claim 1, wherein the contextual information associated with the state of the electronic device includes at least one of an orientation of the electronic device or a position of the electronic device.

8. The method of claim 7, wherein the position of the electronic device includes at least one of:
the device placed on a table with a display facing upward;
the device placed on a table with a display facing downward;
the device placed in a clothing pocket; or
the device placed in a bag.

9. The method of claim 1, wherein the contextual information associated with the state of the electronic device includes at least one of:
an audio mode of the electronic device;
a motion of the electronic device; or
a handheld status of the electronic device.

10. The method of claim 1, wherein adjusting the touch suppression of the capacitive touch screen further comprises:
setting a touch suppression associated with identifying intentional touch contacts.

11. The method of claim 1, wherein adjusting the touch suppression of the capacitive touch screen for identifying intentional touch contacts for the electronic device further comprises:
determining that a first touch suppression associated with identifying intentional touch contacts is suboptimal based on the received contextual information; and
automatically selecting a second touch suppression that corresponds to the contextual information received.

12. The method of claim 11,
wherein determining that the first touch suppression associated with identifying intentional touch contacts is suboptimal based on the contextual information received further comprises:
determining that a signal strength associated with the touch event is below a predefined level; and
wherein selecting the second touch suppression comprises:
applying a dynamic feature normalization to a set of features provided to a machine learning classifier.

13. The method of claim 11,
wherein determining that the first touch suppression is suboptimal is based on detecting a presence of a screen protector on the capacitive touch screen, and
wherein the second touch suppression is selected to increase a touch sensitivity of the capacitive touch screen to compensate for the presence of the screen protector.

14. The method of claim 11, further comprising:
identifying at least one of a grip touch or a palm touch based on the touch event and the received contextual information; and
suppressing the grip touch or the palm touch based on the selected second touch suppression.

15. The method of claim 1, wherein the touch suppression of the capacitive touch screen for identifying intentional touch contacts for the electronic device is adjusted by at least one of:
increasing the touch sensitivity of the electronic device for detecting subsequent touch contacts; or
decreasing the touch sensitivity of the electronic device for detecting subsequent touch contacts.

16. The method of claim 1, further comprising:
adjusting a normalization coefficient for features provided to a machine learning classifier, wherein the adjustment is based on the contextual information received.

17. The method of claim 1, wherein determining the touch sensitivity further comprises:
generating, based on the feature of the touch event, a confidence score for the touch event; and
applying a classifier to the confidence score and the contextual information to determine the touch sensitivity.

18. The method of claim 1,
wherein the feature of the touch event includes at least one strength-dependent feature;
wherein the state of the electronic device is a physical state of the electronic device,
wherein the contextual information further comprises at least one of:
a grounding condition of the electronic device, or
a presence of a screen protector coupled to the capacitive touch screen;
wherein the method further comprises:
applying a dynamic feature normalization to the at least one strength-dependent feature based on the contextual information to generate at least one normalized feature; and
wherein the touch sensitivity is determined based on the at least one normalized feature and the contextual information.

19. An electronic device comprising:
a capacitive touch screen configured to generate touch screen data; and
a processor configured to:
receive touch screen data associated with a touch event on the capacitive touch screen;
extract at least one feature of the touch event from the touch screen data;
receive contextual information associated with a state of the electronic device;
determine, based on the feature and the contextual information, a touch sensitivity indicative of a likelihood of a touch event being a user input; and
adjust, based on the determined touch sensitivity, a touch suppression of the capacitive touch screen.

20. A computer-readable storage medium having stored thereon instructions that, responsive to execution by a processor, cause an electronic device to:
receive touch screen data associated with a touch event on a capacitive touch screen of the electronic device;
extract at least one feature of the touch event from the touch screen data;
receive contextual information associated with a state of the electronic device;
determine, based on the feature and the contextual information, a touch sensitivity indicative of a likelihood of a touch event being a user input; and
adjust, based on the determined touch sensitivity, a touch suppression of the capacitive touch screen.
